(19) United States
(12) Patent Application Publication
(10) Pub. No.: US 2014/0215359 A1
(43) Pub. Date: Jul. 31, 2014

(54) DESKTOP SHARING METHOD AND SYSTEM

(71) Applicant: HON HAI PRECISION INDUSTRY CO., LTD., New Taipei (TW)

(72) Inventor: CHE-CHAUN LIANG, New Taipei (TW)

(73) Assignee: HON HAI PRECISION INDUSTRY CO., LTD., New Taipei (TW)

(21) Appl. No.: 14/151,708

(22) Filed: Jan. 9, 2014

(30) Foreign Application Priority Data
Jan. 25, 2013 (TW) 102102777

(51) Int. Cl. H04L 29/06; G06F 3/048

(52) U.S. Cl. CPC H04L 65/403; G06F 3/048
USPC 715/753

(57) ABSTRACT

A method of sharing data in a computer-implemented system is provided. The system includes at least a publisher device and a viewer device. The system establishes a data communication connection between the publisher device and the viewer device via a Wi-Fi direct (WFD) network. The publisher device sends a desktop sharing request to the viewer device and receiving a first character string from the viewer device. The publisher device receives a second character string input by a user. When the first character string matches the second character string, the publisher device transmits a shared desktop of the publisher device to the viewer device using the data communication connection.

### REFERENCE TO RELATED APPLICATIONS

This application claims all benefits accruing under 35 U.S.C. §119 from Taiwan Patent Application No. 102102777, filed on Jan. 25, 2013 in the Taiwan Intellectual Property Office. The contents of the Taiwan Application are hereby incorporated by reference. In addition, subject matter relevant to this application is disclosed in: co-pending U.S. Patent Application entitled “DESKTOP SHARING METHOD AND SYSTEM,” Attorney Docket Number US50046, Application No. 14/066915, filed on Oct. 30, 2013. This application and the co-pending U.S. Patent Application are commonly owned, and the contents of the co-pending U.S. Patent Applications are hereby incorporated by reference.

### BACKGROUND

1. Technical Field

The disclosure generally relates to data sharing technologies, and particularly relates to desktop sharing methods and systems.

2. Description of Related Art

Desktop sharing allows one user (known as the Publisher) to share the content displayed on the Publisher's monitor with one or more remote users (known as the Viewers) via a local area network (LAN) or the Internet. Either a LAN or the Internet requires at least one third-party network device such as a router or an Internet access point (AP) to establish a desktop sharing session between the devices of the Publisher and the Viewers. However, it may be inconvenient for the Publisher and the Viewers to carry the third-party network device. Under some circumstances, for example, when the Publisher meets the Viewers outdoors, their devices may not have accesses to either a LAN or the Internet, and thus the Publisher cannot share the content displayed on the Publisher's monitor with the Viewers.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the views.

FIG. 1 is a schematic diagram of one embodiment of a computer-implemented system suitable for use in a desktop sharing mode.

FIG. 2 is a block diagram of one embodiment of a device suitable for use in the system of FIG. 1.

FIG. 3 is a flowchart of one embodiment of a method of sharing data in the system shown in FIG. 1.

FIG. 4 is a flowchart of one embodiment of a data sharing method implemented in a publisher device of the system of FIG. 1.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one.”

In general, the word “module,” as used herein, refers to logic embodied in hardware or firmware, or to a collection of software instructions, written in a programming language such as Java, C, or assembly. One or more software instructions in the modules may be embedded in firmware, such as in an erasable-programmable read-only memory (EPROM). The modules described herein may be implemented as either software and/or hardware modules and may be stored in any type of non-transitory computer-readable medium or other storage device. Some non-limiting examples of non-transitory computer-readable media are compact discs (CDs), digital versatile discs (DVDs), Blu-Ray discs, Flash memory, and hard disk drives.

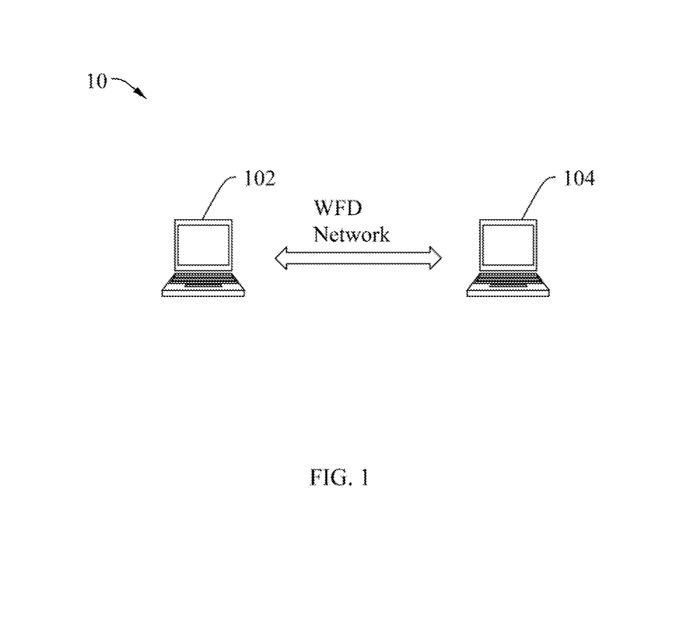

FIG. 1 shows one embodiment of a computer-implemented system 10 that is suitable for use in a desktop sharing mode. The system 10 includes a publisher device 102 and at least one viewer device 104 (only one is shown for simplicity). The system 10 is preferably realized as a computer-implemented system in that the publisher device 102 and the viewer device 104 are configured as computer-based or processor-based electronic devices.

Although only one viewer device 104 is shown in FIG. 1, the system 10 could support any number of viewer devices 104 that are each capable of sharing the desktop display of the publisher device 102. Each user device supported by the system 10 may be implemented using any suitable hardware platform. In this regard, the publisher device 102 and the viewer device 104 may be realized in any common form factor including, without limitation: a desktop computer, a mobile computer (e.g., a tablet computer, a laptop computer, or a netbook computer), a smartphone, a video game device, a digital media player, or the like. The components of the system 10 are suitably configured, programmed, and designed to accommodate the various display, networking, data communication, and data processing features and functions that are needed to support the operation of the system 10 as described in detail here.

Each of the publisher device 102 and the viewer device 104 supports a Wi-Fi direct (WFD) functionality. A data communication connection may be established between the publisher device 102 and the viewer device 104 via a Wi-Fi direct (WFD) network. The WFD network is a network system suggested by the Wi-Fi Alliance and enables Wi-Fi devices to be connected to each other in a peer-to-peer (P2P) fashion without participating in a home network, an office network, or a hot-spot network. Therefore the publisher device 102 may send data directly to the viewer device 104 via the data communication connection without using any third-party network device.

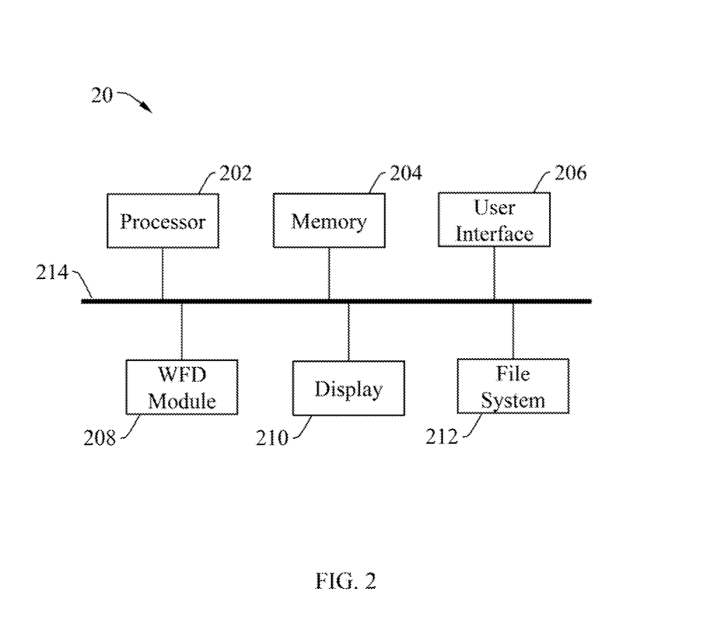

FIG. 2 is a block diagram of an exemplary embodiment of an apparatus, system, or device 20 suitable for use in the system depicted in FIG. 1. In practice, the publisher device 102 and the viewer device 104 could be generally configured and implemented as shown in FIG. 2. Thus, the following general description of the device 20 may be applicable to any of the main components of the system 10 shown in FIG. 1.

The illustrated embodiment of the device 20 includes, without limitation: at least one processor 202, a suitable amount of memory 204, a user interface 206, a WFD module 208, a display 210, and a file system 212. Of course, the device 20 may include additional elements, components, modules, and functionality configured to support various features that are unrelated to the subject matter described here. In practice, the elements of the device 20 may be coupled together via a bus or any suitable interconnection architecture 214.

The processor 202 may be implemented or performed with a general purpose processor, a content addressable memory, a digital signal processor, an application specific integrated circuit, a field programmable gate array, any suitable programmable logic device, discrete gate or transistor logic, discrete hardware components, or any combination designed to perform the functions described here.

The memory 204 may be realized as RAM memory, flash memory, EPROM memory, EEPROM memory, registers, a hard disk, a removable disk, a CD-ROM, or any other form of storage medium known in the art. The memory 204 is coupled to the processor 202 such that the processor 202 can read information from, and write information to, the memory 204. The memory 204 can be used to store computer-executable instructions. The computer-executable instructions, when read and executed by the processor 202, cause the device 20 to perform certain tasks, operations, functions, and processes described in more detail herein.

The user interface 206 may include or cooperate with various features to allow a user to interact with the device 20. Accordingly, the user interface 206 may include various human-to-machine interfaces, e.g., a keypad, keys, a keyboard, buttons, switches, knobs, a touchpad, a joystick, a pointing device, a virtual writing tablet, a touch screen, a microphone, or any device, component, or function that enables the user to select options, input information, or otherwise control the operation of the device 20. In various embodiments, the user interface 206 may include one or more graphical user interface (GUI) control elements that enable a user to manipulate or otherwise interact with an application via the display 210.

The WFD module 208 may establish a P2P data communication connection with another WFD device via a WFD network. In the context of this description, the WFD module 208 can be employed during a desktop sharing session that includes the device 20 as one of the participant devices.

The display 210 is suitably configured to enable the device 20 to render and display various screens, GUIs, GUI control elements, drop down menus, auto-fill fields, text entry fields, message fields, or the like. Of course, the display 210 may also be utilized for the display of other information during the operation of the device 20, as is well understood.

The file system 212 may be implemented using well known and conventional software, firmware, and computer programming technologies. The file system 212 may cooperate with the operating system (OS) of the device 20 to store, manage, and organize electronic data, files, folders, and other items. The file system 212 may be involved when the device 20 shares data with another device.

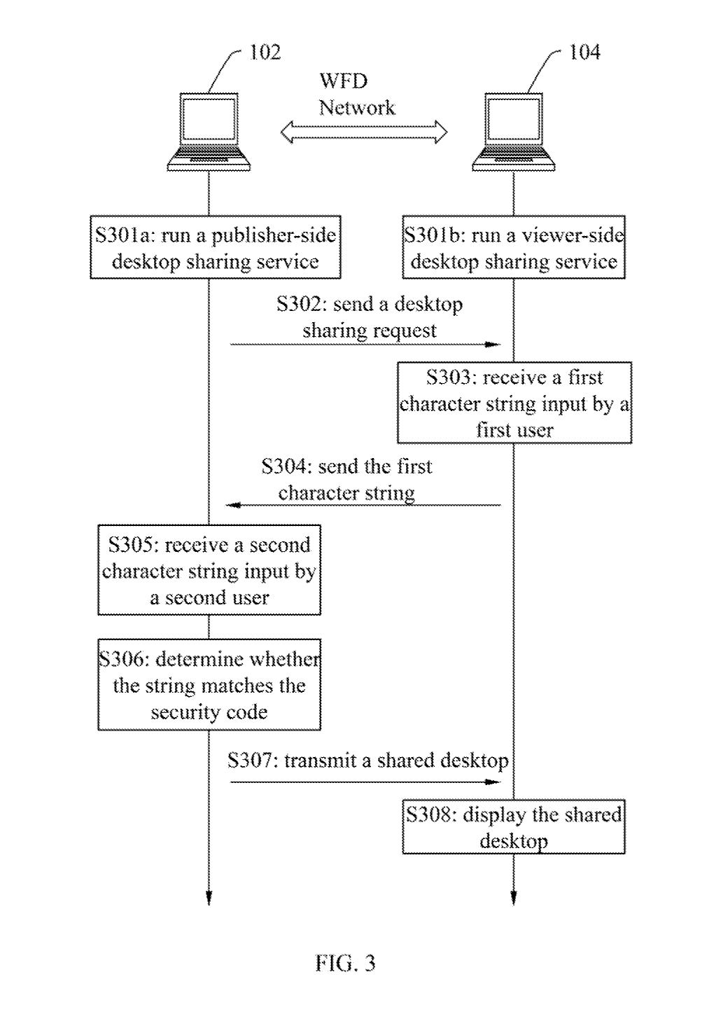

FIG. 3 shows a flowchart of one embodiment of a method of sharing data in the system 10 shown in FIG. 1. The system 10 establishes a data communication connection between the publisher device 102 and the viewer device 104 via a WFD network. The method includes the following steps.

In step S301a, the publisher device 102 runs a publisher-side desktop sharing service. In step S301b, the viewer device 104 runs a viewer-side desktop sharing service.

The viewer-side desktop sharing service is configured to listen to a specific port (e.g. port 4004) of the viewer device 104.

In step S302, the publisher-side desktop sharing service sends a desktop sharing request to the viewer-side desktop sharing service via the specific port of the viewer device 104.

In step S303, the viewer device 104 receives a first character string input by a first user in an user interface. The first character string may include letters, numbers, symbols, or combination thereof.

In step S304, the viewer-side desktop sharing service sends the first character string to the publisher-side desktop sharing service via the specific port of the viewer device 104.

In step S305, the publisher device 102 receives a second character string input by a second user in an user interface. The second character string may include letters, numbers, symbols, or combination thereof.

In step S306, the publisher-side desktop sharing service determines whether the first character string matches the second character string. If the first character string matches the second character string, the flow proceeds to step S307, otherwise, the flow proceeds to step S303.

In step S307, the publisher-side desktop sharing service transmits a shared desktop of the publisher device 102 to the viewer-side desktop sharing service via the specific port of the viewer deice 104.

In step S308, the viewer-side desktop sharing service displays the shared desktop of the publisher device 102 in the viewer device 104.

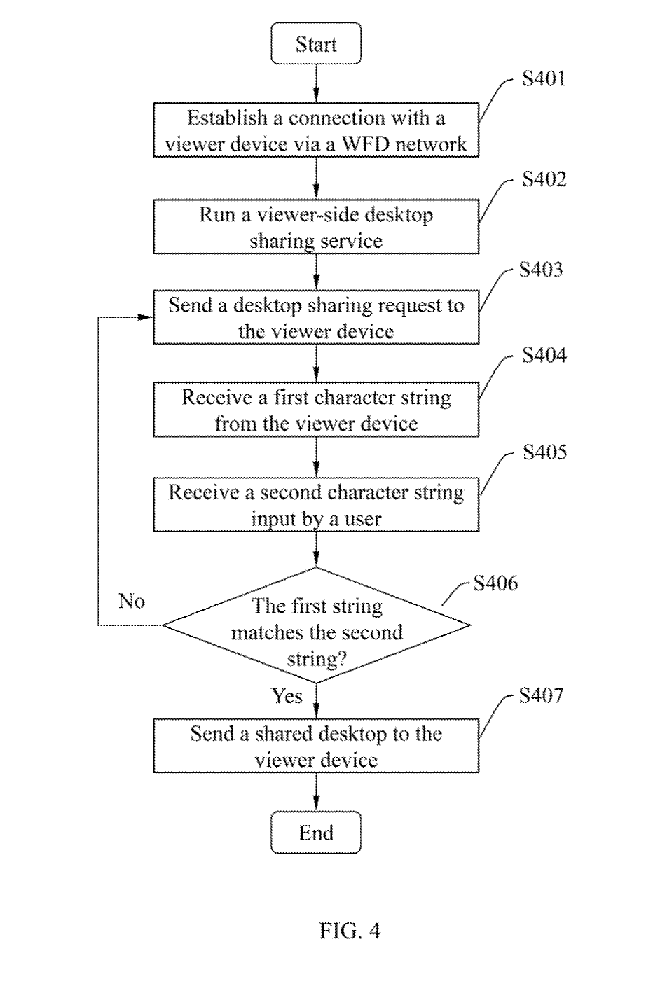

FIG. 4 shows a flowchart of one embodiment of a data sharing method implemented in the publisher device 102. The system 10 establishes a data communication connection between the publisher device 102 and the viewer device 104 via a WFD network. The method includes the following steps.

In step S401, the publisher device 102 establishes a data communication connection with the viewer device 104 via a WFD network.

In step S402, the publisher device 102 runs a publisher-side desktop sharing service.

In step S403, the publisher-side desktop sharing service sends a desktop sharing request to the viewer-side desktop sharing service via a specific port (e.g. port 4004) of the viewer device 104.

In step S404, the publisher-side desktop sharing service receives a first character string from the viewer device 104 via the specific port of the viewer device 104.

In step S405, the publisher device 102 receives a second character string input by a second user in an user interface. The second character string may include letters, numbers, symbols, or combination thereof.

In step S406, the publisher-side desktop sharing service determines whether the first character string matches the second character string. If the first character string matches the second character string, the flow proceeds to step S407, otherwise, the flow proceeds to step S404.

In step S407, the publisher-side desktop sharing service transmits a shared desktop of the publisher device 102 to the viewer device 104 via the specific port of the viewer deice 104.

Although numerous characteristics and advantages have been set forth in the foregoing description of embodiments, together with details of the structures and functions of the embodiments, the disclosure is illustrative only, and changes may be made in detail, especially in the matters of arrangement of parts within the principles of the disclosure to the full extent indicated by the broad general meaning of the terms in which the appended claims are expressed.

In particular, depending on the embodiment, certain steps or methods described may be removed, others may be added, and the sequence of steps may be altered. The description and the claims drawn for or in relation to a method may give some indication in reference to certain steps. However, any indication given is only to be viewed for identification purposes, and is not necessarily a suggestion as to an order for the steps.

What is claimed is:

1. A method of sharing data in a computer-implemented system having a plurality of devices including at least a publisher device and a viewer device, the method comprising:
establishing a data communication connection between the publisher device and the viewer device via a Wi-Fi direct (WFD) network;
sending a desktop sharing request to the viewer device by the publisher device;
receiving a first character string input by a first user in the viewer device;
transmitting the first character string to the publisher device by the viewer device;
receiving a second character string input by a second user in the publisher device;
determining whether the first character string matches the second character string by the publisher device;
when the first character string matches the second character string, transmitting a shared desktop of the publisher device to the viewer device using the data communication connection; and
displaying the shared desktop in the viewer device.

2. The method of claim 1, further comprising:
running a publisher-side desktop sharing service in the publisher device; and
running a viewer-side desktop sharing service in the viewer device.

3. The method of claim 2, further comprising:
listening to a specific port of the viewer device by the viewer-side desktop sharing service; and
receiving the desktop sharing request from the publisher device via the specific port by the viewer-side desktop sharing service.

4. The method of claim 3, wherein the transmitting the shared desktop of the publisher to the viewer device comprises transmitting the shared desktop of the publisher device to the viewer device via the specific port by the publisher-side desktop sharing service.

5. The method of claim 3, further comprising:
when the first character string does not match the second character string, resending the desktop sharing request to the viewer device by the publisher device.

6. A method of sharing data with a viewer device, the method being implemented in a publisher device, the method comprising:
establishing a data communication connection with the viewer device via a Wi-Fi direct (WFD) network;
sending a desktop sharing request to the viewer device;
receiving a first character string from the viewer device;
receiving a second string input by a user in the publisher device;
determining whether the first character string matches the second character string; and
when the first character string matches the second character string, transmitting a shared desktop of the publisher device to the viewer device using the data communication connection.

7. The method of claim 6, further comprising running a publisher-side desktop sharing service.

8. The method of claim 7, wherein the sending the desktop sharing request to the viewer device comprising sending the desktop sharing request to the viewer device via a specific port of the viewer device by the publisher-side desktop sharing service.

9. The method of claim 8, wherein the transmitting the shared desktop of the publisher to the viewer device comprises transmitting the shared desktop of the publisher device to the viewer device via the specific port by the publisher-side desktop sharing service.

10. The method of claim 8, further comprising:
when the first character string does not match the second character string, resending the desktop sharing request to the viewer device.

11. A computer-implemented publisher device comprising a processor and a memory, wherein the memory comprises computer-executable instructions that, when executed by the processor, cause the publisher device to:
establish a data communication connection with a viewer device via a Wi-Fi direct (WFD) network;
send a desktop sharing request to the viewer device;
receive a first character string from the viewer device;
receive a second character string input by a user in the publisher device;
determine whether the first character string matches the second character string; and
when the first character string matches the second character string, transmit a shared desktop of the publisher device to the viewer device using the data communication connection.

12. The publisher device of claim 11, wherein the computer-executable instructions, when executed by the processor, cause the publisher device to run a publisher-side desktop sharing service.

13. The publisher device of claim 12, wherein the computer-executable instructions, when executed by the processor, cause the publisher device to send the desktop sharing request to the viewer device via a specific port of the viewer device by the publisher-side desktop sharing service.

14. The publisher device of claim 13, wherein the computer-executable instructions, when executed by the processor, cause the publisher device to transmit the shared desktop of the publisher device to the viewer device via the specific port by the publisher-side desktop sharing service.

15. The publisher device of claim 13, wherein the computer-executable instructions, when executed by the processor, cause the publisher device to:
when the first character string does not match the second character string, resend the desktop sharing request to the viewer device.
